(19) United States
(12) Patent Application Publication
(10) Pub. No.: US 2006/0195800 A1
(43) Pub. Date: Aug. 31, 2006

(54) Apparatus for displaying screen and recording medium recording a program thereof

(75) Inventor: Satoshi Tahara, Kawasaki (JP)

Correspondence Address: STAAS & HALSEY LLP;JIM LIVINGSTON, SUITE 700, 1201 NEW YORK AVENUE, N.W., WASHINGTON, DC, 20005, US

(73) Assignee: FUJITSU LIMITED, Kawasaki (JP)

(21) Appl. No.: 11/131,419

(22) Filed: May 18, 2005

(30) Foreign Application Priority Data
Feb. 25, 2005 (JP) 2005-50449

(51) Int. Cl. G06F 17/00; G06F 9/00; G06F 3/00

(52) U.S. Cl. 715/856

(57) ABSTRACT

In the present invention, when a client device sends mouse operation information to a server device, the server device performs image processing based on the mouse operation information received from the client device, creates image data including a mouse pointer and sends the image data to the client device. The client device adds a mouse pointer at a current moment to the image data including the mouse pointer, which has been sent from the server device, and outputs both of the mouse pointer created by the server device and the mouse pointer created by the client device on a screen.

### CROSS-REFERENCE TO RELATED APPLICATIONS

This application claims the conventional priority based on Japanese Application No.2005-050449, filed on Feb. 25, 2005, the disclosures of which are incorporated herein by reference.

### BACKGROUND OF THE INVENTION

1. Field of the Invention

The present invention relates generally to a screen display, and particulary to an apparatus for displaying a screen and computer readable recording medium recording a program for displaying a screen that make it possible to display both of information indicating the processing condition of the apparatus and information indicating the processing condition of the server on a screen.

2. Description of the Related Art

It is conceivable that, with development of networks, client devices used by users are provided only with minimum functions and most of processings are performed by server device.

There have been systems in which a client device sends operation information to a server device via a network and outputs a processed image sent from the server device on a screen. In such a system, when delay is caused on the network, screen output responses are deteriorated on the client device. Furthermore, when lack of CPU power is caused on the server device, screen output responses on the client device are also deteriorated.

For example, deterioration of screen output responses to mouse operations or deterioration of screen output responses to keyboard inputs as described below is caused, and thereby the user of the client device feels uncomfortable.

A problem of deterioration of screen output response to mouse operation is described as follows. When screen output responses to mouse operations are deteriorated on a client device, a mouse pointer (cursor) may be fixed or its movement may not be smooth similarly to the case that processing of a personal computer is heavy, for example. Even if the user operates the mouse, the mouse pointer may not move as operated or the mouse pointer may be missed.

A problem of deterioration of screen output response to keyboard input is described as follows. When screen output responses to keyboard inputs are deteriorated on a client device, a condition is caused in which keyboard-inputted characters are not immediately displayed similarly to the case that heavy dictionary software is used on a personal computer with a low-performance CPU or few memory resources, for example.

As examples of mechanisms having the same functions as those of the conventional client device described above, there are a Windows terminal server, Metaflame, Xwindows and Live Help, for example. “Windows”, “Metaflame” and “Live Help” are registered trademarks. In these mechanisms, for example, an image created by a server device and a mouse pointer indicating the processing condition of a client device are displayed together on a screen, on the client device.

An example of conventional screen display will be described with the use of FIG. 17A and FIG. 17B. When a client device sends mouse click operation information to a server device, the server device creates an image as shown in FIG. 17A and sends it to the client device.

FIG. 17B is a diagram showing screen display of client device. On the client device, the image sent from the server device is displayed in a window as shown in FIG. 17B, and a mouse pointer 200 created by the client device is displayed on the screen together. The dotted line shown in FIG. 17B indicates the movement route of the mouse pointer 200 accompanying a mouse operation. In the example of the conventional technique shown in FIG. 17A and FIG. 17B, the server device does not create a mouse pointer.

For example, Live Help has a characteristic that, when the mouse pointer 200 is moved into the window in which the image created by the server device is displayed, the form of the mouse pointer 200 changes into a cross shape as shown in FIG. 18.

Japanese Patent Laid-Open No. 05-53704 describes a technique in which a screen is divided into some input areas, and a method of reporting to a host computer (local echo/host echo/semi-local echo) can be set for each of the input areas. In the technique described in Japanese Patent Laid-Open No. 05-53704, however, information indicating the processing condition of a client device and information indicating the processing condition of a server device are not displayed on a screen together.

In conventional techniques, even if a processing response time is longer than usual due to delay in processing by a server device or delay in a network, the user of a client device cannot know where the problem causing the response delay exists. That is, the user cannot know whether the response delay is caused by the content of the input by the user, by the server device or by the network.

As specific examples of problems of conventional technique, there are a problem about responses to mouse operations, a problem about responses to keyboard inputs and a problem of impossibility of detecting occurrence of response delay, as shown below.

A problem about a responses to a mouse operation is described as follows. In conventional techniques, it is unclear with what level of response information about a mouse operation performed at a client device is communicated to a server device. Accordingly, if a response to a mouse operation is delayed, the user of the client device has a feeling of anxiety since he cannot know whether input of the mouse operation information has failed, a problem has occurred with the client device itself, or the response is only delayed due to the condition of the server device or the network.

A problem about a responses to a keyboard input is described as follows. In the prior-art techniques, when a response to a text input with the use of a keyboard is delayed, the user of the client device also has a feeling of anxiety since he cannot know whether the text input was wrong, a problem has occurred with the client device itself, or the response is only delayed due to the condition of the server device or the network, similarly to the case of the problem about a response to a mouse operation.

A problem of impossibility of detecting occurrence of response delay is described as follows. For conventional systems, there is not a method for detecting how much response delay has been caused. Therefore, the system itself cannot detect response delay, and in the conventional techniques, it is impossible to take appropriate measures when response delay is caused.

### SUMMARY OF THE INVENTION

It is an object of the present invention to provide an apparatus for displaying a screen and computer readable recording medium recording a program for displaying a screen that enable the above problems of the conventional techniques to be solved and displaying information indicating how much delay has been caused in a response from the server to an operation of the apparatus on a screen.

To solve the above problems, in the present invention, the apparatus sends information about an operation of an input device by a user, such as mouse operation information and keyboard input information, to the server via a network. The server receives the operation information from the apparatus and performs image creation processing.

The server creates image data including information indicating the processing condition of the server (for example, a mouse pointer or a result of processing performed in response to keyboard input) and sends it to the apparatus.

The apparatus displays both of information indicating the processing condition of the apparatus(for example, a mouse pointer or keyboard input information) and the image data received from the server on a screen.

As a result, on the apparatus, both of a mouse pointer indicating the processing condition of the apparatus and a mouse pointer indicating the processing condition of the server, for example, are displayed on a screen.

Furthermore, on the apparatus, both of keyboard input information inputted by the apparatus and a result of processing performed by the server in response to the keyboard input are displayed on a screen.

As described above, in the present invention, both of information indicating the processing condition of the apparatus and information indicating the processing condition of the server are displayed on a screen. Thus, according to the present invention, it is possible to easily determine whether the server or the network has a problem or an operation by the user of the apparatus has a problem.

Furthermore, in the present invention, delay in a response to operation information sent from an apparatus for displaying a screen to a server is detected by the apparatus, and if the degree of the response delay exceeds a predetermined threshold, both of information indicating the processing condition of the apparatus and information indicating the processing condition of the server are displayed on a screen.

According to the present invention, it is possible to display information indicating the degree of response delay on a screen when the response delay has increased to some degree.

That is, the present invention provides an apparatus for displaying a screen and connected to a server via a network. The apparatus comprises an operation information input unit inputting information of an input-device operation by a user, an operation information sending unit sending the inputted input-device operation information to the server, an image information receiving unit receiving from the server a first cursor image information created on the server based on the input-device operation information, a cursor creation unit creating a second cursor image information based on the inputted input-device operation information, and a screen output unit outputting both of the first cursor image information and the second cursor image information on the screen.

Preferably, in the present invention, the apparatus further comprises a delay time detection unit detecting time of delay in a response from the server, wherein the screen output unit outputs both of the first cursor image information and the second cursor image information on the screen when the response delay time detected by the delay time detection unit exceeds a predetermined threshold.

Preferably, in the present invention, the delay time detection unit comprises a delay confirmation packet creation and sending unit creating a delay confirmation packet in which a first delay confirmation number, which is a number to detect the time of delay in a response from the server, is stored and sending the delay confirmation packet to the server, and a delay time calculation unit receiving from the server a response data in which a second delay confirmation number which is same with the first delay confirmation number is stored, and calculating the time of delay in a response from the server based on difference between the time when the delay confirmation packet is sent to the server and the time when the response data is received from the server.

Preferably, in the present invention, the operation information sending unit stores a third delay confirmation number, which is a number to detect the time of delay in a response from the server, in the inputted input-device operation information, and sends the inputted input-device operation information to the server. The image information receiving unit receives from the server image information including the first cursor image information in which a delay confirmation number is stored. The delay time detection unit comprises delay time calculation unit calculating time of delay in a response from the server based on difference between the time when the input-device operation information is sent to the server and the time when the image information including the first cursor image information, in which a fourth delay confirmation number which is same as the third delay confirmation number is stored, is received.

Furthermore, the present invention provides an apparatus for displaying a screen and connected to a server via a network. The apparatus comprises a keyboard input unit inputting keyboard input information, a keyboard input information sending unit sending the inputted keyboard input information to the server, an image information receiving unit receiving from the server an image information indicating a result of processing performed in response to the keyboard input information, the image information having been created in the server, a character image creation unit creating a character image based on the keyboard input information inputted by the keyboard input unit, and a screen output unit outputting both of the image information created on the server and the character image created by the character image creation unit on a screen.

Preferably, in the present invention, the server further comprises an operation information receiving unit receiving the inputted input-device operation information from the apparatus, an image information creation unit creating image information including the first cursor image information on the server based on the input-device operation information received from the apparatus, an image information sending unit sending the image information created by the image information creation unit to the apparatus, a delay confirmation packet receiving unit receiving the delay confirmation packet sent from the apparatus, and response data creation and sending unit creating a response data in which the second delay confirmation number which is same as the first delay confirmation number stored in the received delay confirmation packet is stored, and sending the response data to the apparatus.

Preferably, in the present invention, the server further comprises an operation information receiving unit receiving the inputted input-device operation information from the apparatus, and extracting the third delay confirmation number from the received input-device operation information, an image information creation unit creating image information including the first cursor image information on the server based on the received input-device operation information, and an image information sending unit sending the image information created by the image information creation unit to the apparatus. The image information creation unit stores in the image information to be created the fourth delay confirmation number which is same as the extracted third delay confirmation number.

Furthermore, the present invention provides a computer readable recording medium recording a program for displaying a screen. The program is executed by a computer of an apparatus for displaying a screen which is connected to a server via a network. The program causes the computer to execute inputting information of an input-device operation by a user, sending the inputted input-device operation information to the server, receiving from the server a first cursor image information created on the server based on the inputted input-device operation information, creating a second cursor image information based on the inputted input-device operation information, and outputting both of the first cursor image information and the second cursor image information on the screen.

In the present invention, both of information indicating the processing condition of a n apparatus for displaying a screen and information indicating the processing condition of a server are displayed on a screen. Thus, according to the present invention, it is possible to easily determine whether the server or the network has a problem or the apparatus or an operation by the user of the apparatus has a problem.

For example, in the present invention, both of a mouse pointer created by the server and a mouse pointer created by the apparatus are displayed on a screen on the apparatus.

According to the present invention, it is possible to show the user of apparatus how much delay has been caused in a response to a mouse operation performed on the apparatus.

Thus, according to the present invention, it is possible to eliminate the user's frustration and reduce influence of response deterioration. That is, it is possible to improve the user's feeling about a response.

For example, in the present invention, both of keyboard input information inputted by an apparatus for displaying a screen and a result of processing performed by a server in response to the keyboard input are displayed on a screen on the apparatus.

According to the present invention, it is possible to show the user of the apparatus how much delay has been caused in the response to the keyboard input performed by the apparatus. Furthermore, it is possible for the user of the apparatus to confirm that his keyboard input was not wrong. Thus, according to the present invention, it is possible to eliminate the user's frustration and reduce influence of response deterioration. That is, it is possible to improve the user's feeling about a response.

Furthermore, in the present invention, if response delay is detected by the apparatus for displaying a screen and the degree of the response delay exceeds a predetermined threshold, then both of a mouse pointer created by the server and a mouse pointer created by the apparatus may be displayed on a screen. Alternatively, both of keyboard input information inputted by the apparatus and a result of processing performed by the server in response to the keyboard input may be displayed. Thus, according to the present invention, it is possible to take measures for eliminating a user's frustration and reducing influence of response deterioration when response delay has increased to some degree.

### BRIEF DESCRIPTION OF THE DRAWINGS

FIG. 1 shows an example of the system configuration of the present invention.

FIG. 2 shows an example of image data sent from a server device.

FIG. 3A and FIG. 3B show an example of screen display on a client device.

FIG. 4 shows an example of screen display on the client device.

FIG. 5A through FIG. 5D show image data created by the client device, image data created by the server device and image data to be displayed on a screen by the client device.

FIG. 6 illustrates calculation of response delay time.

FIG. 7A and FIG. 7B illustrate an example of a delay time calculation process.

FIG. 8 shows a process procedure in a third embodiment.

FIG. 9A and FIG. 9B illustrate an example of a delay time calculation process.

FIG. 10 shows a process procedure in a fourth embodiment.

FIG. 11A and FIG. 11B illustrate an example of the delay time calculation process.

FIG. 12 shows a process procedure in a fifth embodiment.

FIG. 13 illustrates an example of a process to be performed when a mouse operation is performed.

FIG. 14 illustrates an example of a process to be performed when a mouse operation is performed.

FIG. 15 illustrates an example a process to be performed when keyboard input is performed.

FIG. 16 illustrates an example a process to be performed when keyboard input is performed.

FIG. 17A and FIG. 17B illustrate an example of conventional screen display.

FIG. 18 illustrates an example of conventional screen display.

### DETAILED DESCRIPTION OF THE PREFERRED EMBODIMENTS

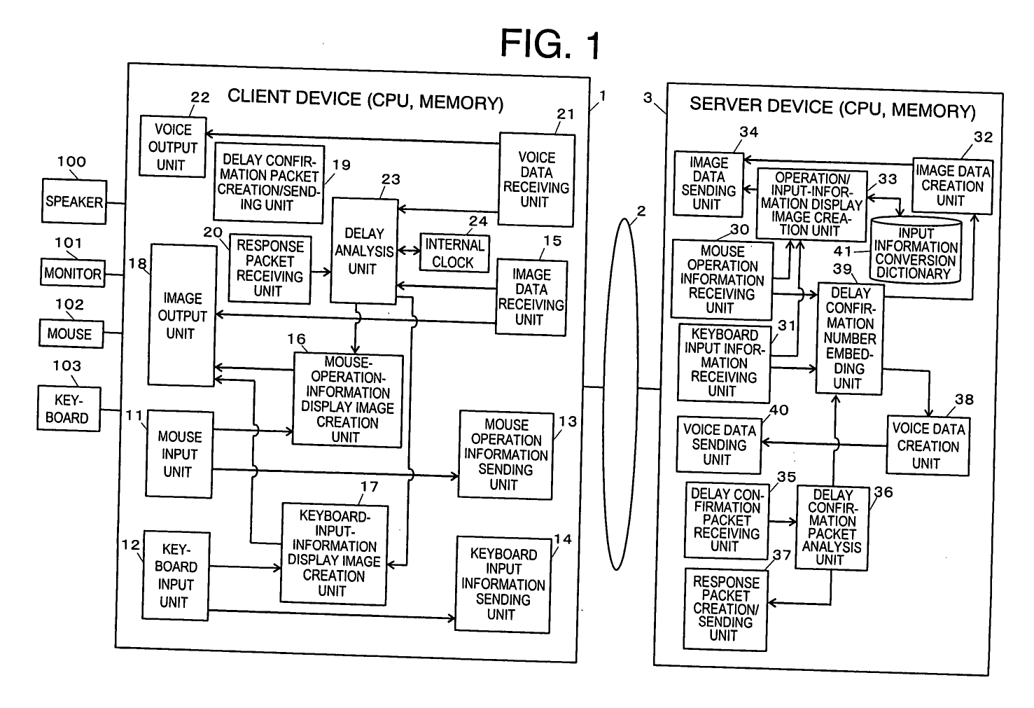

FIG. 1 shows an example of the system configuration of the present invention. A client device 1, which is an apparatus for displaying a screen, is connected to a server device 3 via a network 2. Both of the client device 1 and the server device 3 are realized by hardware of a CPU and a memory.

To the client device 1, there are connected output devices such as a speaker 100 and a monitor 101 and input devices such as a mouse 102 and a keyboard 103. The client device 1 performs an input operation with the use of the mouse 102 or the keyboard 103 and sends the operation information to the server device 3 via the network 2.

The server device 3 receives the operation information sent from the client device 1, creates image data including information indicating the processing condition of the server device 3 (for example, a mouse pointer and a result of processing performed in response to the keyboard operation) and sends it to the client device 1.

The client device 1 displays both of information indicating the processing condition of the client device 1 (for example, a mouse pointer and keyboard input information) and the image data received from the server device on a screen of the monitor 101.

On the client device 1, a mouse input unit 11 inputs operation information about the mouse 102 (mouse operation information). A keyboard input unit 12 inputs input information about the keyboard 103 (keyboard input information). A mouse operation information sending unit 13 sends the inputted mouse operation information to the server device 3. A keyboard input information sending unit 14 sends the inputted keyboard input information to the server device 3.

An image data receiving unit 15 receives the image data created by the server device 3. A mouse-operation-information display image creation unit 16 creates a mouse pointer based on the mouse operation information inputted by the mouse input unit 11.

A keyboard-input-information display image creation unit 17 creates a character image based on the keyboard input information inputted by the keyboard input unit 12.

An image output unit 18 outputs both of the image data created by the server device 3 and sent from the image data receiving unit 15 and the mouse pointer created by the mouse operation information display image creation unit 16 on a screen of the monitor 101. The image output unit 18 also outputs both of the image data created by the server device 3 and sent from the image data receiving unit 15 and the character image created by the keyboard-input-information display image creation unit 17 on a screen of the monitor 101.

A delay confirmation packet creation/sending unit 19 creates a delay confirmation packet, a packet for detecting delay in a response to the client device 1 from the server device 3 and sends the packet to the server device 3. The delay confirmation packet creation/sending unit 19 describes a delay confirmation number which uniquely identifies the delay confirmation packet, in the delay confirmation packet.

A response packet receiving unit 20 receives the response packet sent from the server device 3. In the response packet, the delay confirmation number of the delay confirmation packet sent from the client device 1 to the server device 3 is described.

A voice data receiving unit 21 receives voice data sent from the server device 3. A voice output unit 22 outputs the voice data to the speaker 100.

A delay analysis unit 23 analyzes delay in a response from the server 3 based on the delay confirmation number described in the response packet received by the response packet receiving unit 20. In a case a delay confirmation number is described in the image data received by the image data receiving unit 15, the delay analysis unit 23 analyzes response delay based on the delay confirmation number.

In a case a delay confirmation number is described in the voice data received by the voice data receiving unit 21, the delay analysis unit 23 analyzes delay in a response based on the delay confirmation number. Reference numeral 24 denotes an internal clock.

On the server device 3, a mouse operation information receiving unit 30 receives the mouse operation information from the client device 1. A keyboard input information receiving unit 31 receives the keyboard input information from the client device 1.

An image data creation unit 32 performs image processing based on the mouse operation information or the keyboard input information received from the client device 1 and sends the created image data to an image data sending unit 34.

An operation/input-information display image creation unit 33 creates an image indicating a mouse pointer or a result of processing performed in response to the keyboard input based on the mouse operation information or the keyboard input information, and sends it to the image data sending unit 34.

The operation/input-information display image creation unit 33 creates Japanese kana-kanji character image data, with the use of an input information conversion dictionary 41 based on the keyboard input information, as required.

In the input information conversion dictionary 41, there is stored dictionary data to be used by software for converting keyboard input information to create character data.

The image data sending unit 34 sends the image data created by the image data creation unit 32 and the image indicating a mouse pointer or a result of processing performed in response to the keyboard input, which has been created by the operation/input-information display image creation unit 33 to the client device 1.

A delay confirmation packet receiving unit 35 receives a delay confirmation packet from the client device 1. A delay confirmation packet analysis unit 36 analyzes the delay confirmation packet and extracts a delay confirmation number. A response packet creation/sending unit 37 creates a response packet in which the delay confirmation number extracted by the delay confirmation packet analysis unit 36 is embedded and sends the packet to the client device 1.

A voice data creation unit 38 creates voice data. A delay confirmation number embedding unit 39 embeds the delay confirmation number in the mouse operation information, the keyboard input information or the delay confirmation packet received from the client device 1, in image data created by the image data creation unit 32.

The delay confirmation number embedding unit 39 embeds the delay confirmation number in the mouse operation information, the keyboard input information or the delay confirmation packet received from the client device 1, in voice data created by the voice data creation unit 38.

A voice data sending unit 40 sends the voice data created by the voice data creation unit 38 to the client device 1.

A first embodiment of the present invention will be described below. In the first embodiment of the present invention, the client device 1 displays both of a mouse pointer indicating the processing condition of the client device 1 and a mouse pointer indicating the processing condition of the server device 3 on a screen.

When mouse operation information is inputted by the mouse input unit 11, the mouse operation information sending unit 13 sends the mouse operation information to the server device 3. The mouse operation information sending unit 13 sends absolute coordinate information, for example, “from 200 to 211 on the vertical axis, and from 100 to 134 on the horizontal axis”.

The mouse operation information receiving unit 30 of the server device 3 receives the mouse operation information from the client device 1. The image data creation unit 32 performs image processing based on the mouse operation information received by the mouse operation information receiving unit 30. The image data creation unit 32 creates graphic data indicating, for example, a circle, a triangle, a parallelogram and the like.

The operation/input-information display image creation unit 33 creates a mouse pointer indicating the processing condition of the server device 3 based on the mouse operation information.

The image data sending unit 34 sends the image data created by the image data creation unit 32 and the mouse pointer created by the operation/input-information display image creation unit 33 to the client device 1.

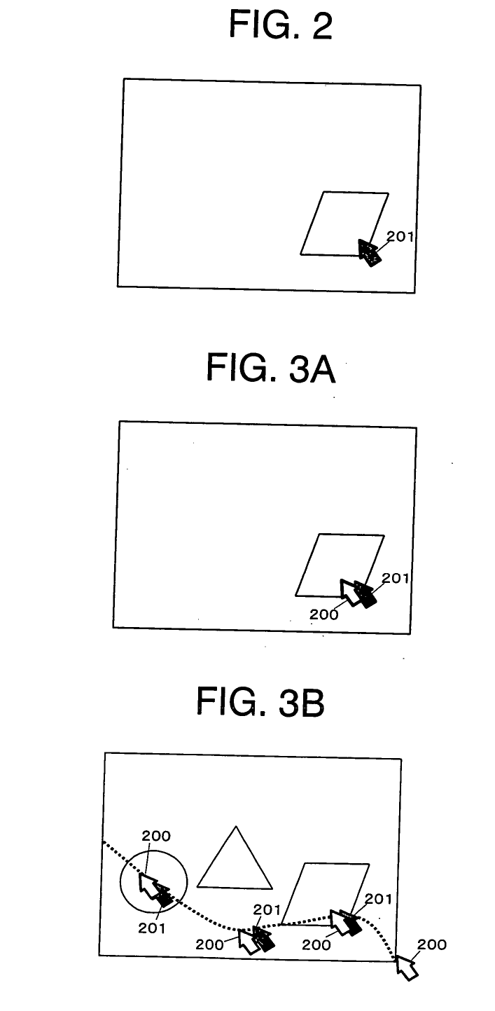

For example, the image data sending unit 34 sends image data in which both of a parallelogram which is the image data created by the image data creation unit 32 and a mouse pointer 201 created by the operation/input-information display image creation unit 33 are displayed, to the client device 1 as shown in FIG. 2.

The image data receiving unit 15 of the client device 1 sends the image data sent from the server device 3 to the image output unit 18.

The mouse-operation-information display image creation unit 16 of the client device 1 creates a mouse pointer indicating the processing condition of the client device 1.

The image output unit 18 outputs both of the image data received from the server device 3 and the mouse pointer created by the mouse-operation-information display image creation unit 16 on a screen.

For example, the image output unit 18 outputs both of the image data received from the server device 3 and the mouse pointer 200 created by the mouse-operation-information display image creation unit 16 on a screen, as shown in FIG. 3A.

For example, if the mouse pointer 200 created by the client device 1 moves along a route denoted by a dotted line in FIG. 3B, then the mouse pointer 201 indicating the processing condition of the server device 3 follows the mouse pointer 200 with a delay corresponding to response delay if any.

Thus, according to the first embodiment of the present invention, it is possible for the user of the client device 1 to know how much a response to a mouse operation is delayed.

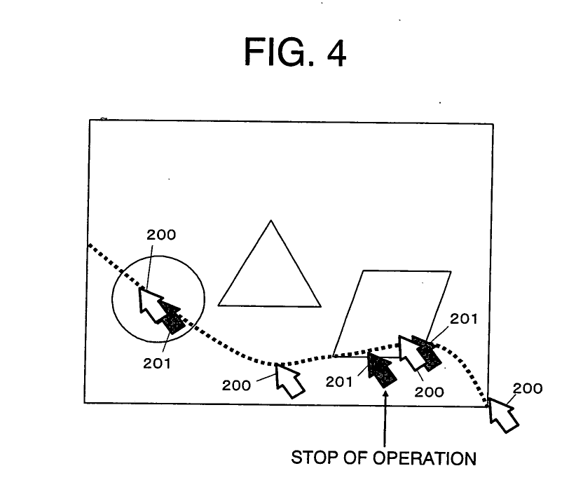

FIG. 4 shows an example of screen display on the client device when a packet loss is caused. If a packet loss is caused and mouse operation information is not communicated to the server device 3, then there is caused a time zone where the mouse pointer 201 created by the server device 3 does not move.

Thus, according to the first embodiment of the present invention, it is possible for the user of the client device 1 to know whether input of the mouse operation information has failed or response delay is simply caused, that is, whether the operation response deterioration on the screen is caused by the user himself or it is caused by the computer system side.

A second embodiment of the present invention will be now described. In the second embodiment of the present invention, the client device 1 outputs both of keyboard input information inputted by the client device 1 and a result of processing performed by the server device 3 in response to the keyboard input on a screen.

When keyboard input information is inputted by the keyboard input unit 12, the keyboard input information sending unit 14 sends the keyboard input information to the server device 3. For example, the keyboard input information sending unit 14 sends keyboard input information “kyoha [conversion] haretemasune [conversion]”.

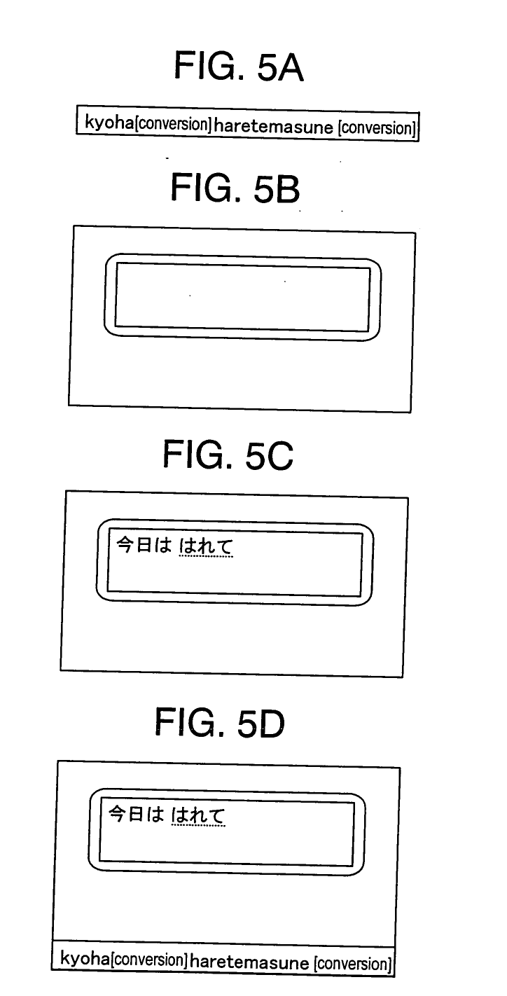

The keyboard-input-information display image creation unit 17 also creates a character image based on the keyboard input information. For example, the keyboard-input-information display image creation unit 17 creates image data as shown in FIG. 5A.

The keyboard input information receiving unit 31 of the server device 3 receives the keyboard input information from the client device 1. The image data creation unit 32 performs image processing based on the keyboard input information received by the keyboard input information receiving unit 31. For example, the image data creation unit 32 creates image data as shown in FIG. 5B.

The operation/input-information display image creation unit 33 creates character image data based on the keyboard input information. For example, the operation/input-information display image creation unit 33 creates character image data [symbol] based on the keyboard input information “kyoha [conversion] haretemasune [conversion]” with the use of the input information conversion dictionary 41.

The image data sending unit 34 sends the image data created by the image data creation unit 32 and the character image data created by the operation/input-information display image creation unit 33 to the client device 1.

For example, the image data sending unit 34 sends image data, in which the characters [symbol] are displayed to the client device 1 as shown in FIG. 5C. In the example of FIG. 5C, the portion which properly should be displayed as [symbol] is displayed with [symbol] underlined and not kanji-converted because the [symbol] is being character-converted by the server device 3.

When the image data receiving unit 15 of the client device 1 receives the image data sent from the server device 3, the image output unit 18 outputs both of the image data created by the server device 3 and the character image created by the keyboard-input-information display image creation unit 17 on the monitor 101.

For example, the image output unit 18 outputs both of an image created by the server device 3, in which characters [symbol] are displayed, and a character image of “kyoha [conversion] haretemasune [conversion]” created by the client device 1 on a screen, as shown in FIG. 5D.

In the example shown in FIG. 5D, a part of “kyoha [conversion] haretemasune [conversion]” has been converted into Japanese kana-kanji characters and displayed on a screen because of delay in a response from the server device 3.

Thus, according to the second embodiment of the present invention, it is possible for the user of the client device 1 to know how much delay has been caused in a response to the keyboard input.

For example, if a packet loss is caused and keyboard input information is not communicated to the server device 3, then there is caused a time zone where the image indicating a result of processing performed by the server device 3 in response to the keyboard input does not move on a screen displayed by the client device 1.

Thus, according to the second embodiment of the present invention, it is possible for the user of the client device 1 to know whether keyboard input information has not been communicated to the server device 3 or response delay has been caused.

A third embodiment of the present invention will be now described. In the third embodiment of the present invention, the client device 1 detects delay in a response to operation information sent from the client device 1 to the server device 3. If the degree of the response delay exceeds a predetermined threshold, then the client device 1 displays both of information indicating the processing condition of the client device 1 and information indicating the processing condition of the server device 3 on a screen.

In the third embodiment, the delay confirmation packet creation/sending unit 19 of the client device 1 creates a delay confirmation packet, a packet for detecting delay in a response from the server device 3. The delay confirmation packet creation/sending unit 19 describes a delay confirmation number, a number which uniquely identifies the delay confirmation packet, in the delay confirmation packet.

The delay confirmation packet creation/sending unit 19 then sends a delay confirmation packet to the server device 3 at a constant interval. For example, the delay confirmation packet creation/sending unit 19 sends a delay confirmation packet to the server device 3 at time a.

The delay confirmation packet receiving unit 35 of the server device 3 receives the delay confirmation packet, and the delay confirmation packet analysis unit 36 extracts a delay confirmation number from the received delay confirmation packet.

Then, the response packet creation/sending unit 37 creates a response packet in which the extracted delay confirmation number is described and sends it to the client device 1.

When the response packet receiving unit 20 of the client device receives the response packet, the delay analysis unit 23 checks the delay confirmation number in the response packet.

For example, if the delay confirmation number in the response packet received from the server device 3 at time b is the same number as the delay confirmation number embedded in the delay confirmation packet sent to the server device 3 at the time a, then the delay analysis unit 23 calculates the time b minus the time a as the response delay time.

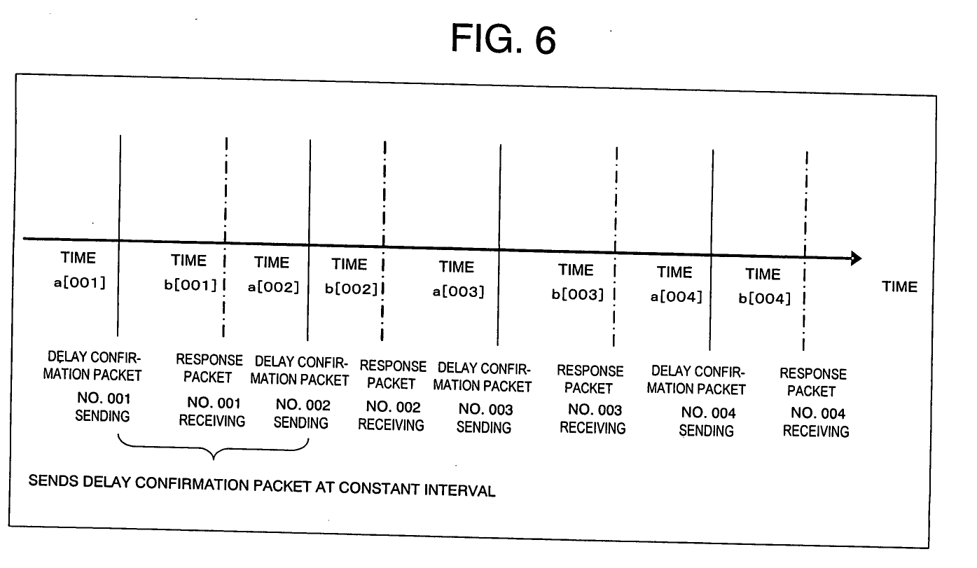

The calculation of the response delay time will be specifically described with the use of FIG. 6. For example, the client device 1 sends a delay confirmation packet in which a delay confirmation number 001 is embedded, a delay confirmation packet in which a delay confirmation number 002 is embedded, a delay confirmation packet in which a delay confirmation number 003 is embedded and a delay confirmation packet in which a delay confirmation number 004 is embedded to the server device 3 in that order at constant time intervals. The numbers enclosed in square brackets and placed below “time” in FIG. 6 indicate delay confirmation numbers.

For example, the client device 1 sends the delay confirmation packet in which the delay confirmation number 001 is embedded to the server device 3 at the time a[001]. Then, when receiving a responses packet in which the delay confirmation number 001 is embedded from the server device 3 at the time b[001], the client device 1 calculates the time b[001] minus the time a[001] as the response delay time for the delayed packet 001.

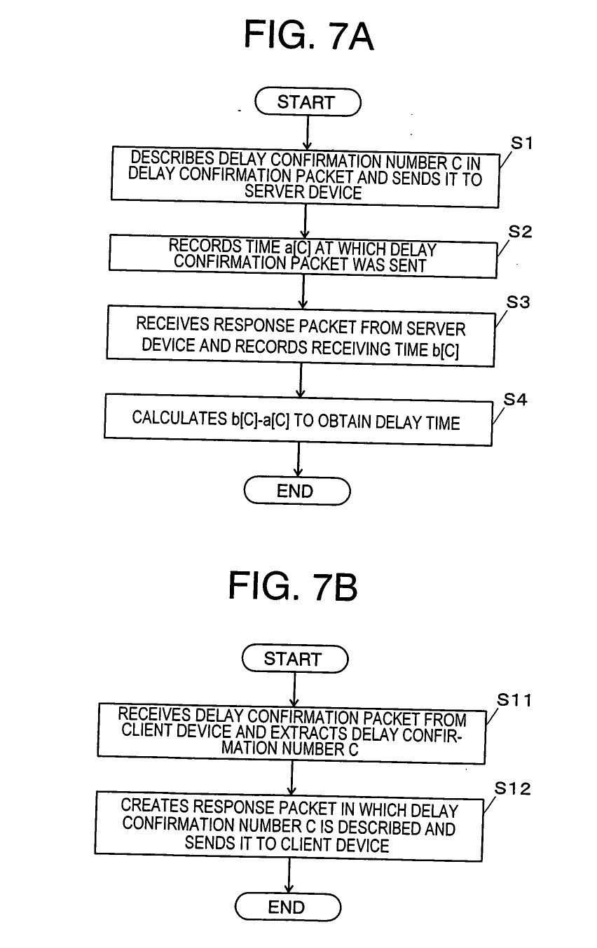

FIG. 7A and FIG. 7B illustrate an example of a delay time calculation process. FIG. 7A shows an example of an operational process flow in the client device 1, and FIG. 7B shows an example of an operational process flow in the server device 3.

As shown in FIG. 7A, the client device 1 describes a delay confirmation number C in a delay confirmation packet and sends the packet to the server device 3 (step S1). Furthermore, the client device 1 records the time a[C] at which it sent the delay confirmation packet (step S2).

The client device 1 receives a response packet from the server device 3 and records the receiving time b[C] (step S3). Then, the client device 1 calculates b[C] minus a[C] to obtain a delay time (step S4).

As shown in FIG. 7B, the server device 3 receives a delay confirmation packet from the client device 1 and extracts a delay confirmation number C (step S11). The server device 3 creates a response packet in which the delay confirmation number C is described and sends the packet to the client device 1 (step S12).

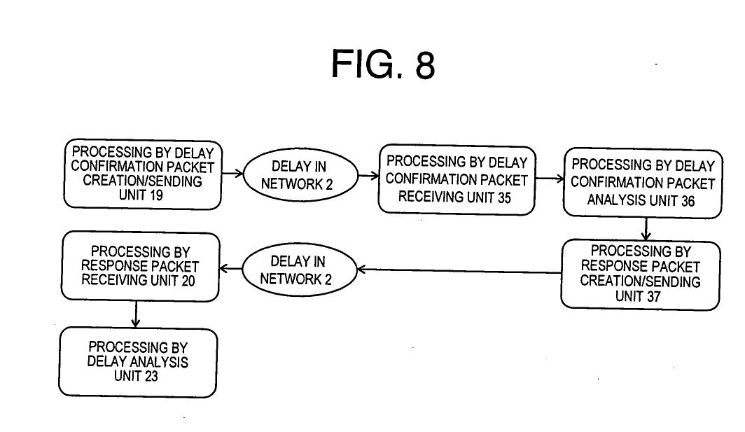

According to the third embodiment, the delay time in the process procedure shown by arrows in FIG. 8 is calculated. In this case, it is not important to measure delay time caused by processings performed for detecting response delay (processings performed by the delay confirmation packet creation/sending unit 19, the delay confirmation packet receiving unit 35, the delay confirmation packet analysis unit 36, the response packet creation/sending unit 37, the response packet receiving unit 20 and the delay analysis unit 23).

The main operational advantage of the third embodiment is that a delay time to which delay in the network 2 is added is calculated.

When the calculated delay time exceeds a predetermined threshold, the delay analysis unit 23 of the client device 1 sends a control signal to the mouse-operation-information display image creation unit 16 or the keyboard-input-information display image creation unit 17 to cause a mouse pointer or a character image to be sent out to the image output unit 18.

According to the third embodiment, it is possible that, if the delay time is below the threshold, only one of the mouse pointer 200 created by the client device 1 and the mouse pointer 201 indicating the processing condition of the server device 3 is displayed, and when the delay in the network 2 is increased to some degree, both of information indicating the processing condition of the client device 1 and information indicating the processing condition of the server device 3 are displayed on a screen. Furthermore, according to the third embodiment, even if the time is not synchronized between the server device 3 and the client device 1, it is possible to accurately measure response delay time.

A fourth embodiment of the present invention will be now described. The fourth embodiment is different from the third embodiment in that the server device 3 embeds a delay confirmation number in a delay confirmation packet received from the client device 1 in image data or voice data and sends the data to the client device 1. Furthermore, in the fourth embodiment, the image data receiving unit 15 and the voice data receiving unit 21 have a function of extracting the delay confirmation number in the data sent from the server device 3.

In the fourth embodiment, the delay confirmation packet creation/sending unit 19 of the client device 1 creates a delay confirmation packet and sends it to the server device 3 at a constant interval.

The delay confirmation packet receiving unit 35 of the server device 3 receives the delay confirmation packet, and the delay confirmation packet analysis unit 36 extracts a delay confirmation number from the delay confirmation packet.

The delay confirmation number embedding unit 39 embeds the extracted delay confirmation number in image data created by the image data creation unit 32 or voice data created by the voice data creation unit 38.

As a method for embedding a delay confirmation number, there are various adoptable methods such as embedding the delay confirmation number in a particular position on data to be sent to the client device 1 or utilizing various electronic watermark techniques.

The image data sending unit 34 or the voice data sending unit 40 sends the image data or the voice data in which the delay confirmation number is embedded, to the client device 1. The image data receiving unit 15 or the voice data receiving unit 21 of the client device 1 extracts the delay confirmation number in the image data or voice data received from the server device 3.

Then, the delay analysis unit 23 calculates response delay time based on the time at which the delay confirmation packet was sent to the client device 1 and the time at which the same delay confirmation number as the delay confirmation number in the delay confirmation packet was extracted by the image data receiving unit 15 or the voice data receiving unit 21.

If the calculated delay time exceeds a predetermined threshold, then the delay analysis unit 23 sends a control signal to the mouse-operation-information display image creation unit 16 or the keyboard-input-information display image creation unit 17 to cause a mouse pointer or a character image to be sent out to the image output unit 18.

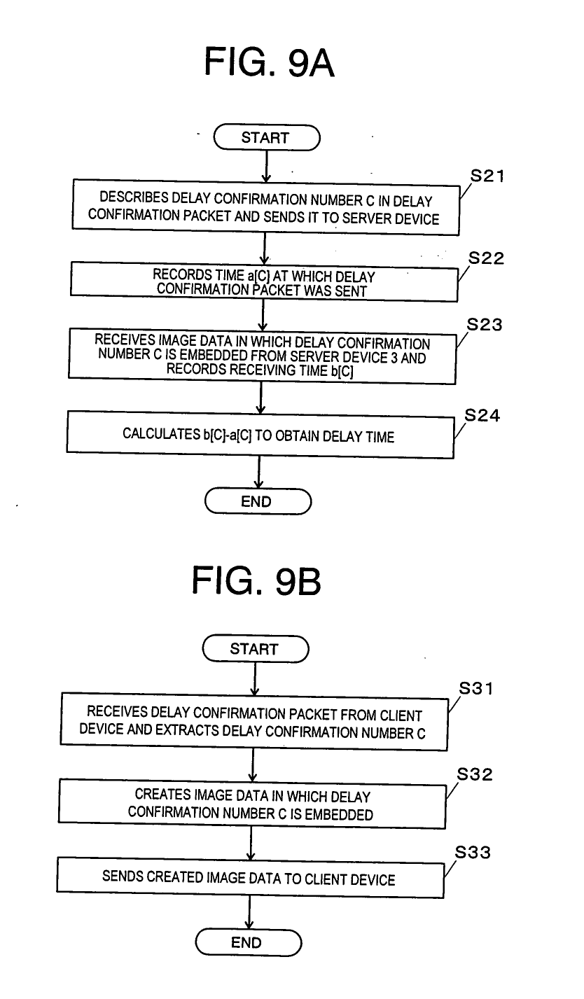

FIG. 9A and FIG. 9B illustrate an example of a delay time calculation process. FIG. 9A shows an example of an operational process flow in the client device 1, and FIG. 9B shows an example of an operational flow in the server device 3.

As shown in FIG. 9A, the client device 1 describes a delay confirmation number C in a delay confirmation packet and sends it to the server device 3 (step S21). The client device 1 also records the time a[C] at which it sent the delay confirmation packet (step S22).

The client device 1 receives the image data in which the delay confirmation number C is embedded from the server device 3 and records the receiving time b[C] (step S23). The client device 1 then calculates b[C] minus a[C] to obtain the delay time (step S24).

As shown in FIG. 9B, the server device 3 receives the delay confirmation packet from the client device 1 and extracts the delay confirmation number C (step S31). The server device 3 creates image data in which the delay confirmation number C is embedded (step S32) and sends the created image data to the client device 1 (step S33).

According to the fourth embodiment, if a delay confirmation number is embedded in image data by the server device 3, for example, it is possible to calculate delay time including network delay and delay in image processing by the server device 3. Furthermore, if a delay confirmation number is embedded in voice data by the server device 3, it is possible to calculate delay time including network delay and delay in voice processing by the server device 3.

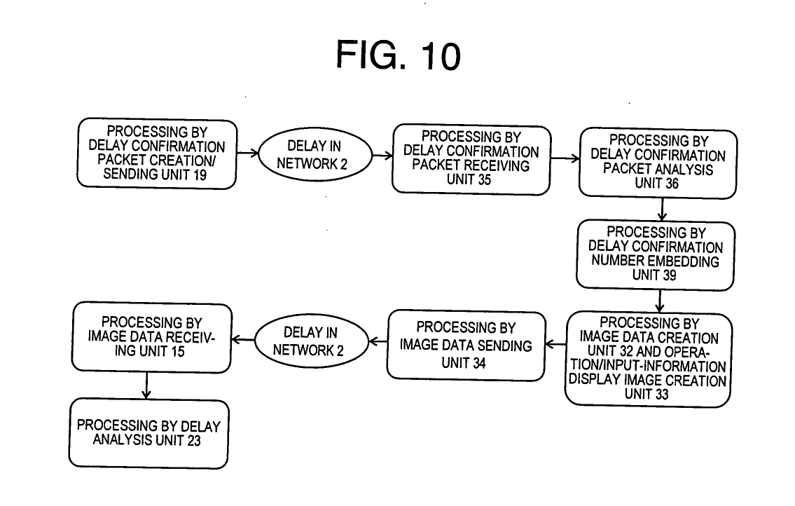

According to the fourth embodiment, for example, the delay time in the process procedure shown by arrows in FIG. 10 is calculated. In this case, it is not important to measure delay time caused by processings performed for detecting response delay (the processings performed by the delay confirmation packet creation/sending unit 19, the delay confirmation packet receiving unit 35, the delay confirmation packet analysis unit 36, the delay confirmation number embedding unit 39, the image data receiving unit 15 and the delay analysis unit 23).

The main operational advantage of the fourth embodiment is that a delay time to which delay in the network 2, delay in the processing by the image data creation unit 32, delay in the processing by the operation/input-information display image creation unit 33 and delay in the processing by the image data sending unit 34 are added is calculated.

A fifth embodiment of the present invention will be now described. In the fifth embodiment, the client device 1 embeds a delay confirmation number in mouse operation information or keyboard input information and sends it to the server device 3.

In the fifth embodiment, the mouse operation information sending unit 13 and the keyboard input information sending unit 14 of the client device 1 have a function of embedding a delay confirmation number in data to be sent to the server device 3. The mouse operation information receiving unit 30 and the keyboard input information receiving unit 31 have a function of extracting the delay confirmation number in the data sent from the client device 1.

In the fifth embodiment, for example, the mouse operation information sending unit 13 of the client device 1 embeds a delay confirmation number in mouse operation information and sends it to the server device 3. The mouse operation information receiving unit 30 of the server device 3 extracts the delay confirmation number in the mouse operation information received from the client device 1 and sends it to the delay confirmation number embedding unit 39.

The delay confirmation number embedding unit 39 embeds the extracted delay confirmation number in image data created by the image data creation unit 32 or voice data created by the voice data creation unit 38.

The image data sending unit 34 or the voice data sending unit 40 sends the image data or voice data in which the delay confirmation number is embedded to the client device 1.

A response delay time calculation process performed after the client device 1 receives the image data or the voice data from the server device 3 is similar to that in the fourth embodiment described above.

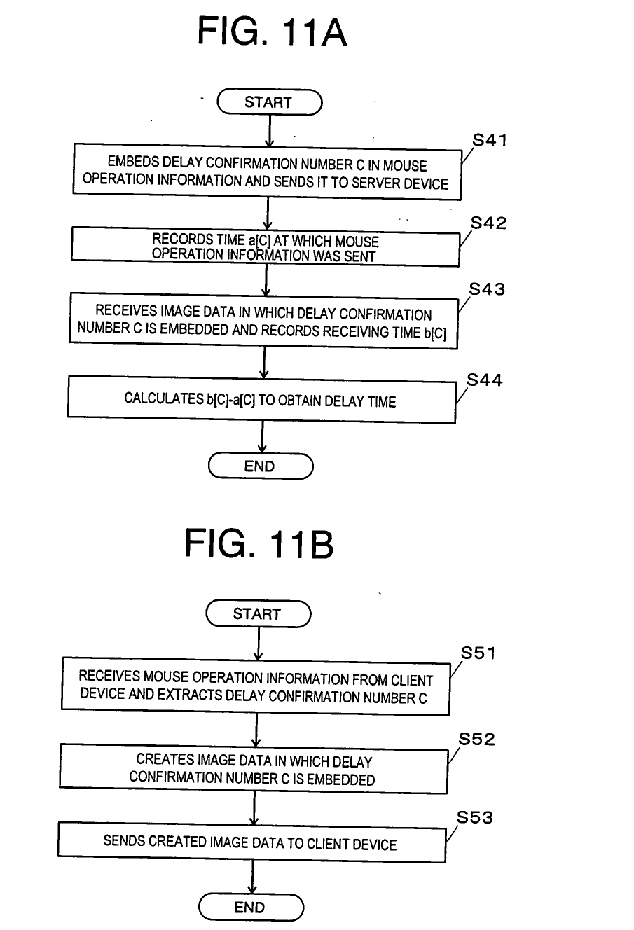

FIG. 11A and FIG. 11B illustrate an example of a delay time calculation process. The FIG. 11A shows an example of an operational process flow in the client device 1, and FIG. 11B shows an example of an operational process flow in the server device 3.

As shown in FIG. 11A, the client device 1 embeds a delay confirmation number C in mouse operation information and sends it to the server device 3 (step S41). Furthermore, the client device 1 records the time a[C] at which it sent the mouse operation information (step S42).

The client device 1 receives image data in which the delay confirmation number C is embedded and records the receiving time b[C] (step S43). Then, the client device 1 calculates b[C] minus a[C] to obtain a delay time (step S44).

As shown in FIG. 11B, the server device 3 receives the mouse operation information and extracts the delay confirmation number C (step S51). The server device 3 creates image data in which the delay confirmation number C is embedded (step S52), and sends the created image data to the client device 1 (step S53).

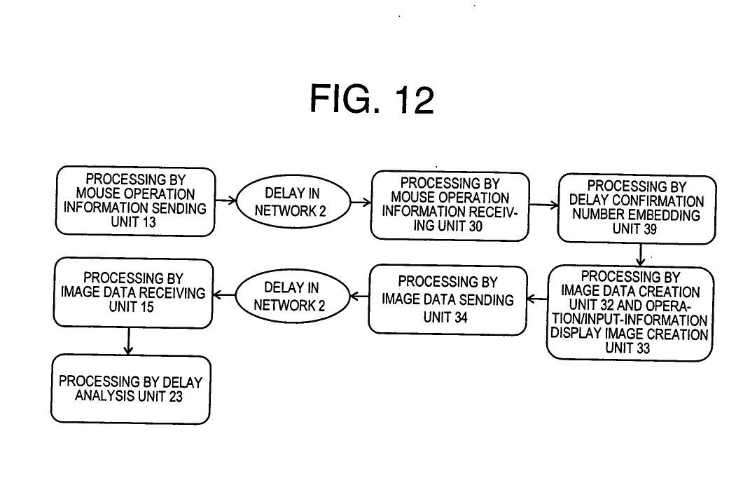

According to the fifth embodiment, the delay time in the process procedure shown by arrows in FIG. 12 is calculated. In this case, it is not important to measure delay time caused by processings performed by the mouse operation information receiving unit 30, the delay confirmation number embedding unit 39, the image data receiving unit 15 and the delay analysis unit 23.

The main operational advantage of the fifth embodiment is that a delay time to which delay in the processing by the mouse operation information sending unit 13, delay in the network 2, delay in the processing by the image data creation unit 32, delay in the processing by the operation/input-information display image creation unit 33 and delay in the processing by the image data sending unit 34, for example, are added is calculated.

Thus, according to the fifth embodiment, it is possible to detect a delay time to which delay in the processing by the server device 3 is added.

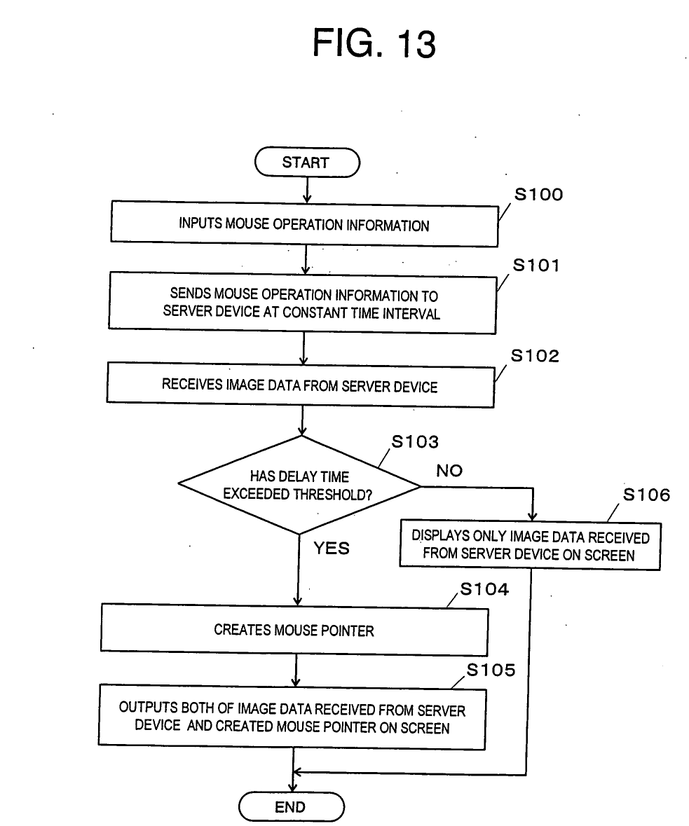

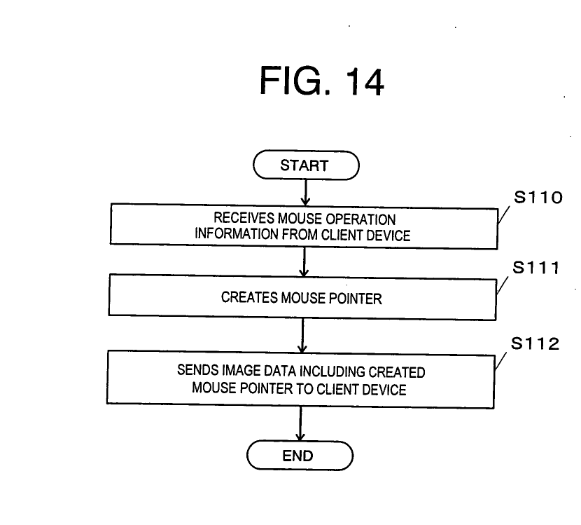

FIGS. 13 and 14 illustrate an example of a process to be performed when a mouse operation is performed on the client device 1. FIG. 13 shows an example of operation process flow in the client device 1, and FIG. 14 shows an example in the server device 3.

As shown in FIG. 13, the client device 1 inputs mouse operation information (step S100), and sends the mouse operation information to the server device 3 at a constant time interval (step S101). When receiving image data from the server device 3 (step S102), the client device 1 determines whether the delay time exceeds a threshold (step S103). If the delay time exceeds the threshold, then the client device 1 creates a mouse pointer (step S104), and outputs both of the image data received from the server device 3 and the created mouse pointer on a screen (step S105). If the delay time has not exceeded the threshold, then the client device 1 outputs only the image data received from the server device 3 on a screen (step S106).

It is also possible for the client device 1 to create a mouse pointer (step S104) and output only the created mouse pointer on a screen, instead of step S106.

As shown in FIG. 14, the server device 3 receives mouse operation information from the client device 1 (step S110), and creates a mouse pointer (step S111). The server device 3 then sends image data including the created mouse pointer to the client device 1 (step S112).

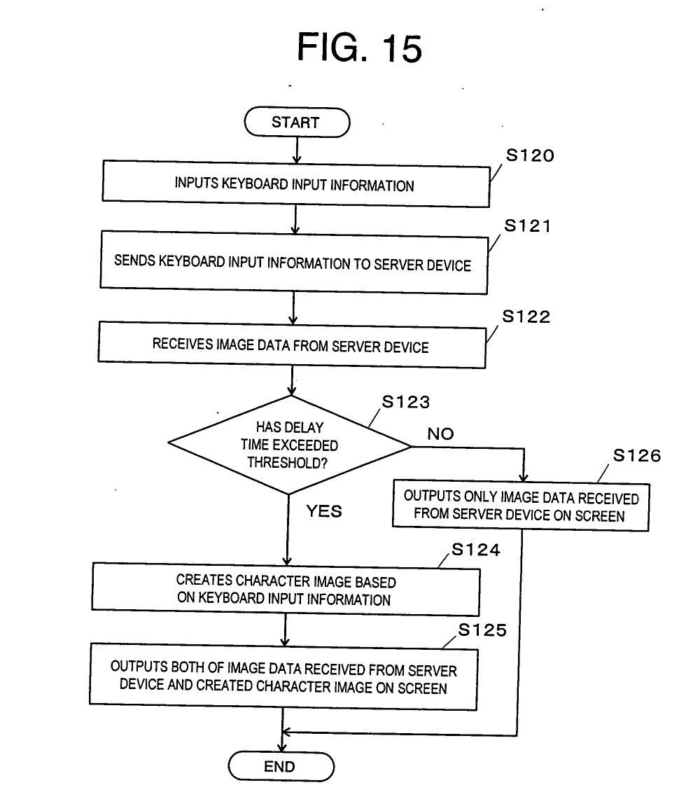

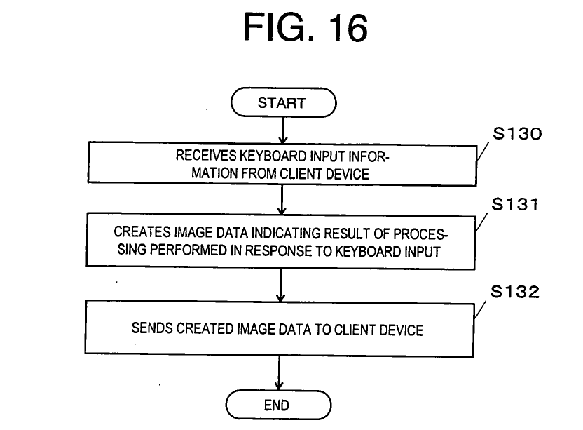

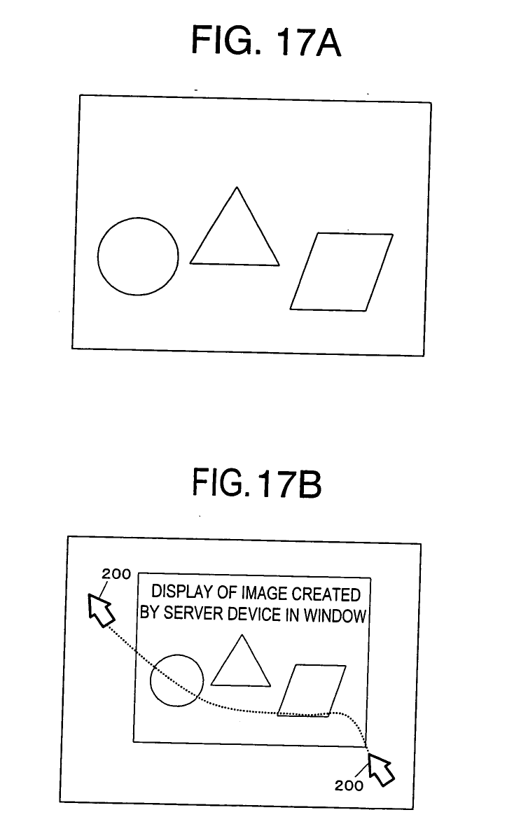

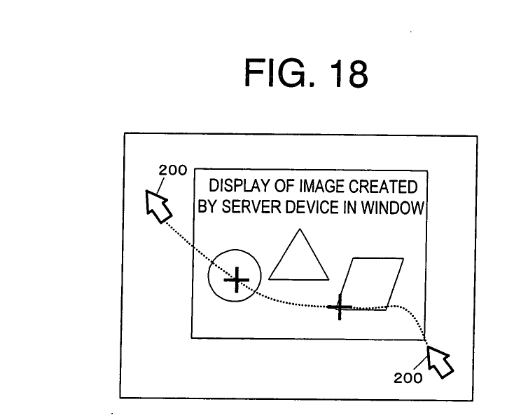

FIGS. 15 and 16 illustrate an example of a process to be performed when keyboard input is performed on the client device 1. FIG. 15 shows an example of an operational process flow in the client device 1, and FIG. 16 shows an example of an operational process flow in the server device 3.

As shown in FIG. 15, the client device 1 inputs keyboard input information (step S120), and sends the keyboard input information to the server device 3 (step S121). When receiving image data from the server device 3 (step S122), the client device 1 determines whether the delay time exceeds the threshold (step S123). If the delay time exceeds the threshold, then the client device 1 creates a character image based on the keyboard input information (step S124) and outputs both of the image data received from the server device 3 and the created character image on a screen (step S125). If the delay time has not exceeded the threshold, the client device 1 outputs only the image data received from the server device 3 on a screen (step S126).

It is also possible for the client device 1 to create a character image based on the keyboard input information (step S124) and output only the created character image on a screen, instead of step S126.

As shown in FIG. 16, the server device 3 receives keyboard input information from the client device 1 (step S130) and creates image data indicating a result of processing performed in response to the keyboard input(step S131). The server device 3 then sends the created image data to the client device 1 (step S132).

In the above embodiments, the mouse 102 has been described as an example of an input device of the client device 1. However, it is apparent that the present invention is similarly applicable to a pointing device such as a tablet and a touch panel.

The present invention can be also embodied as a program to be read and executed by a computer. The program to realize the present invention can be stored in an appropriate recording medium, such as a portable media memory, a semiconductor memory and a hard disk, which can be read by a computer. The program is recorded to such a recording medium and provided. Alternatively, it is provided through sending and receiving with the use of a network via a communication interface.

What is claimed is:

1. An apparatus for displaying a screen, the apparatus being connected to a server via a network, the apparatus comprising:
an operation information input unit inputting information of an input-device operation by a user;
an operation information sending unit sending the inputted input-device operation information to the server;
an image information receiving unit receiving from the server a first cursor image information created on the server based on the input-device operation information;
a cursor creation unit creating a second cursor image information based on the inputted input-device operation information; and
a screen output unit outputting both of the first cursor image information and the second cursor image information on the screen.

2. The apparatus according to claim 1, further comprising:
a delay time detection unit detecting time of delay in a response from the server,
wherein the screen output unit outputs both of the first cursor image information and the second cursor image information on the screen when the response delay time detected by the delay time detection unit exceeds a predetermined threshold.

3. The apparatus according to claim 2, wherein the delay time detection unit further comprises:
a delay confirmation packet creation and sending unit creating a delay confirmation packet in which a first delay confirmation number, which is a number to detect the time of delay in a response from the server, is stored and sending the delay confirmation packet to the server; and
a delay time calculation unit receiving from the server a response data in which a second delay confirmation number which is same with the first delay confirmation number is stored, and calculating the time of delay in a response from the server based on difference between the time when the delay confirmation packet is sent to the server and the time when the response data is received from the server.

4. The apparatus according to claim 2,
wherein the operation information sending unit stores a third delay confirmation number, which is a number to detect the time of delay in a response from the server, in the inputted input-device operation information, and sends the inputted input-device operation information to the server,
wherein the image information receiving unit receives from the server image information including the first cursor image information in which a delay confirmation number is stored,
wherein the delay time detection unit comprises delay time calculation unit calculating time of delay in a response from the server based on difference between the time when the input-device operation information is sent to the server and the time when the image information including the first cursor image information, in which a fourth delay confirmation number which is same as the third delay confirmation number is stored, is received.

5. An apparatus for displaying a screen, the apparatus being connected to a server via a network, the apparatus comprising:
a keyboard input unit inputting keyboard input information;
a keyboard input information sending unit sending the inputted keyboard input information to the server;
an image information receiving unit receiving from the server an image information indicating a result of processing performed in response to the keyboard input information, the image information having been created in the server;
a character image creation unit creating a character image based on the keyboard input information inputted by the keyboard input unit; and
a screen output unit outputting both of the image information created on the server and the character image created by the character image creation unit on a screen.

6. The apparatus according to claim 3, wherein the server further comprises:
an operation information receiving unit receiving the inputted input-device operation information from the apparatus;
an image information creation unit creating image information including the first cursor image information on the server based on the input-device operation information received from the apparatus;
an image information sending unit sending the image information created by the image information creation unit to the apparatus;
a delay confirmation packet receiving unit receiving the delay confirmation packet sent from the apparatus; and
response data creation and sending unit creating a response data in which the second delay confirmation number which is same as the first delay confirmation number stored in the received delay confirmation packet is stored, and sending the response data to the apparatus.

7. The apparatus according to claim 4, wherein the server further comprises:
an operation information receiving unit receiving the inputted input-device operation information from the apparatus, and extracting the third delay confirmation number from the received input-device operation information;
an image information creation unit creating image information including the first cursor image information on the server based on the received input-device operation information; and
an image information sending unit sending the image information created by the image information creation unit to the apparatus, and
wherein the image information creation unit stores in the image information to be created the fourth delay confirmation number which is same as the extracted third delay confirmation number.

8. A computer readable recording medium recording a program for displaying a screen, the program executed by a computer of an apparatus for displaying a screen, the apparatus being connected to a server via a network, the program causing the computer to execute:
inputting information of an input-device operation by a user;
sending the inputted input-device operation information to the server;
receiving from the server a first cursor image information created on the server based on the inputted input-device operation information;
creating a second cursor image information based on the inputted input-device operation information; and
outputting both of the first cursor image information and the second cursor image information on the screen.
